(19) United States
(12) Patent Application Publication
(10) Pub. No.: US 2015/0169943 A1
(43) Pub. Date: Jun. 18, 2015

(54) SYSTEM, METHOD AND APPARATUS FOR BIOMETRIC LIVENESS DETECTION

(71) Applicants: Alexey Khitrov, New York, NY (US); Konstantin Simonchik, Saint-Petersburg (RU); Dmitry Dyrmovsky, Moscow (RU)

(72) Inventors: Alexey Khitrov, New York, NY (US); Konstantin Simonchik, Saint-Petersburg (RU); Dmitry Dyrmovsky, Moscow (RU)

(21) Appl. No.: 14/107,300

(22) Filed: Dec. 16, 2013

(51) Int. Cl. G06K 9/00

(52) U.S. Cl. CPC G06K 9/00288; G06K 9/00255; G06K 9/00248

(57) ABSTRACT

A system, method and apparatus is disclosed for detection in a biometric system including the obtaining of a sequence of user's face images and making a decision about the presence of a dummy on the images. A distinctive feature of invention includes sequencing of images of the user made at the same time when the user pronounces a passphrase. In addition, predetermined mimic facial characteristics of the user are calculated, then predetermined statistic parameters of every mimic characteristic are calculated, and on this basis a coefficient of changes of the mimic characteristics within the sequence of images is calculated. The coefficient is compared with the predetermined threshold, and the decision of liveness detection on the sequence of images is concluded.

### BACKGROUND OF THE INVENTION

1. Field of the Present Invention

The present invention relates generally to biometric authentication, in particular, to a system method and apparatus for bimodal user verification by face and voice, and can be used in the systems intended for prevention of unauthorized access to premises or information resources.

2. Background of the Related Art

Biometric identification is the process of automatic identity confirmation based on the individual information contained, in particular, into audio signals and face images. This process might be divided to identification and verification. Thus the identification procedure detects which one of the presented speakers exactly talks, and the verification procedure consists in determining of match or mismatch of the speaker's identity. Verification can be used to control access to the restricted services, such as telephone access to banking transactions, shopping or access to secret equipment.

Usually a usage of this technology consists in pronouncing of a short phrase to the microphone by the user and making a photo of his face. After that some acoustic characteristics (sounds, frequencies, pitches, and other physical characteristics of the voice channels that are commonly referred to as sound characteristics) and individual facial traits (the positions of nose, eyes, corners of the mouth, etc.) are determined and measured. Then these characteristics are utilized to determine a set of unique audio and video parameters of the user (so-called “voice model” and “facial model”). Usually this procedure is called registration. In this case a registration is the obtaining of a voice sample and a face image. Voice and facial models are stored with the personal identifiers and used in security protocols. During the verification procedure the user is ordered to repeat the phrase used for his registration and to make a photo of his face. The voice verification algorithm realizes the comparison of user's voice with the voice sample made during the registration procedure; and the face verification algorithm realizes the comparison of user's face with the face image made during the registration procedure. Then the verification technology accepts or rejects the user's attempt to map over the voice and facial samples. If the samples are matched, the user is given a secure access. Otherwise the secure access will be denied for this user.

Due to rapid biometric authentication systems development, a liveness detection for these systems becomes an actual problem. For breaking the voice verification system a recording (or a collection of recording) of the system's user might be used as an imitation; and for breaking the face verification system might be used a photo, a video recording or a three-dimensional dummy of the system's user.

There is a liveness detection method described in U.S. Pat. No. 8,355,530 entitled “Liveness Detection Method and Apparatus of Video Image”, that includes tracking of changes in the characteristic image points of the of a person's face within a sequence of frames. The method involves an affine transformation of the tracked points from frame to frame; a calculation of liveness L based on the calculation of the distance between the characteristic points after the affine transformation and the decision based on the coefficient L about whether an image in the sequence of frames is a picture or is an image of a live person. The disadvantage of this approach is that the input data is only the sequence of video frames, and that the method may be deceived if a violator uses a video recording of a live person made at any time or a three-dimensional dummy of its head.

There is also a method described in U.S. Pat. No. 8,442,824 entitled “Device, System, and Method of Liveness Detection Utilizing Voice Biometrics”, the essence of which consists in combining a text dependent and a text independent analysis method. A compliance degree is determined between the voice models built with a passphrase told by the user during the registration in the system and built with the same passphrase told by the user at verification. The compliance degree is determined between any phrase pronounced by the user during the registration and a phrase asked by the system and pronounced during the verification. The compliance degree is determined between the passphrase and a phrase pronounced by the user during the verification. In addition whether the asked phrase was pronounced correctly by the user is verified. On the basis of analysis of the obtained comparisons and with the result of phrase pronouncing validation a determination is made whether the user was a live person at all of the verification stages or a recorded voice used.

There is also a liveness detection method described in Russian Federation Patent No. 2316051 entitled “Method and System for Automatic Liveness Detection of a Live Person's Face in Biometric Security Systems”, that describes a detection method for checking a head dummy on basis of using three-dimensional sensors for analysis of a three-dimensional object as well as its parts moving in accordance with the interactive user actions. Also disclosed is a method to protect a biometric recognition system against the controlled holographic dummy with using the set of interactive commands from the command generation unit (a DBMS) to the system's display which enforce the user to perform some mechanic (i.e. kinesthetic) actions with a material object in the detection area, for example, to lift an object or to press a button. However, the disadvantage of this approach is a high cost and bulkiness of the three-dimensional analysis sensors, and the necessity for the user to perform certain actions that are not directly related to its identification.

### OBJECTS OF THE INVENTION

An object of the invention is to create a biometric authentication system that can defeat unauthorized access by identifying false images such as the usage of a dummy or a false audio and/or video recording during the biometric bimodal authentication process (by face and voice).

Another object of the invention is to provide a system to authenticate and verify biometric variation in an efficient and cost effective manner.

### SUMMARY OF THE INVENTION

The present invention includes a system, method and apparatus for liveness detection realized at the same time with an authentication procedure, where the user does not need to perform any additional action not related with the successful authentication. During a passphrase pronunciation a user's facial expression changes: his mouth opens, his eyes open wider and narrowly or/and his pupils move. Consequently during the utterance of a passphrase an estimation of the user's facial expressions is statistically predictable and allows the system to apply an analysis of facial expressions.

In a first embodiment, the present invention includes a method having the following steps presented in the following sequence of actions: during the bimodal authentication when pronouncing a passphrase, collecting photos of the user's face over a set of equal time periods; calculating mimicked facial characteristics for each image; calculating a coefficient of changes between the mimic facial characteristics of all images; comparing a coefficient calculated with a predetermined threshold value; and performing a liveness detection decision based on the comparison.

In some embodiments there includes a step of calculating mimicked facial characteristics further comprises determining at least one of the following: a probability of the user's mouth opening; a probability of the user's right eye opening; a probability of the user's left eye opening; a probability of the position of the user's pupil of the left and right eye in the forward direction and respectively, a probability of the position of the user's pupil of the left eye in the forward direction; and a probability of the position of the user's pupil of the right eye in the forward direction.

Some embodiments may include calculating statistic parameters for each mimic characteristic, determining a median value, counting a series of images and a predetermined ordinal number of an image.

Some embodiments include determining a maximum deviation from the median, determining a maximum scatter, determining a coefficient of mimic characteristics.

Some embodiments assigning a weighting coefficient for a position of at least one of a user's eyes, mouth, nose and/or pupils.

In a second embodiment, the present invention includes an apparatus having computer storage, a database, a central processor and a gui all electrically interconnected, where the computer storage contains computer software having instructions to collect photos over a set time period during the bimodal authentication when pronouncing a passphrase, calculate mimicked facial characteristics for each image; calculate a coefficient of changes between the mimic facial characteristics of all images; compare a coefficient calculated with a predetermined threshold value; and perform a liveness detection decision based on the comparison.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a block diagram showing an exemplary computing environment in which aspects of the present invention may be implemented;

FIG. 2 shows the functional diagram of the liveness detection procedure according to one embodiment of the invention; and

FIG. 3 shows the detailed diagram of the detector for presence of a dummy on a sequence of images according to one embodiment of the invention.

### DETAILED DESCRIPTION OF THE PREFERRED EMBODIMENTS

The present disclosure will now be described more fully with reference the to the Figures in which an embodiment of the present disclosure is shown. The subject matter of this disclosure may, however, be embodied in many different forms and should not be construed as being limited to the embodiments set forth herein.

Exemplary Operating Environment

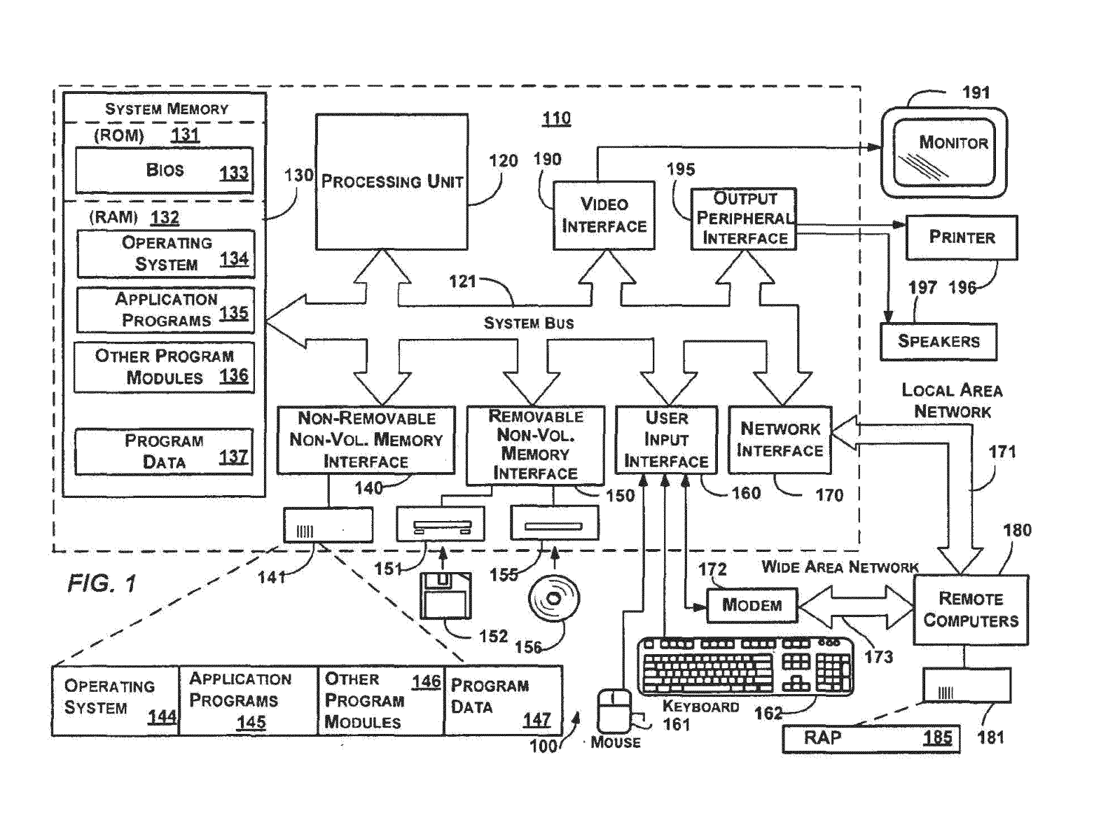

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Existing authentication methods may be compromised with a passphrase recording or a face image. However implementation of the present invention permits an increase in reliability of such biometric verification. For instance, it has been found that if the false acceptance probability of a biometric bimodal authentication system is 1%, at usage of high quality voice recording and photo by the violator this error increases to 98-99%. The use of liveness detector in the second case reduces the false acceptance error to 5-20% depending on the setting of decision thresholds

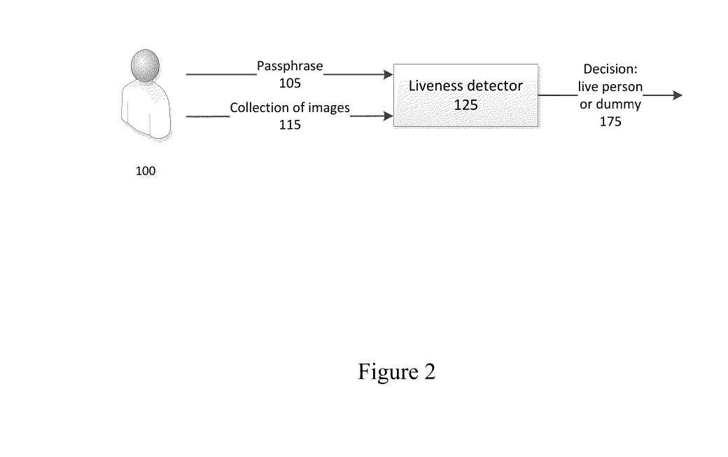

Referring now to FIG. 2 the present invention is shown according to a preferred embodiment which includes the process recording User's 100 voice passphrase 105. During the voice recording process some full-face user's 100 photos/images 110 are made. A first photo is taken at the initial time of the passphrase recording and the other ones are taken in certain time periods (typically no longer than 1 second). The last photo of the user's face is made at the final time of the passphrase recording in order to begin the liveness detector process 125 to reach decision 175.

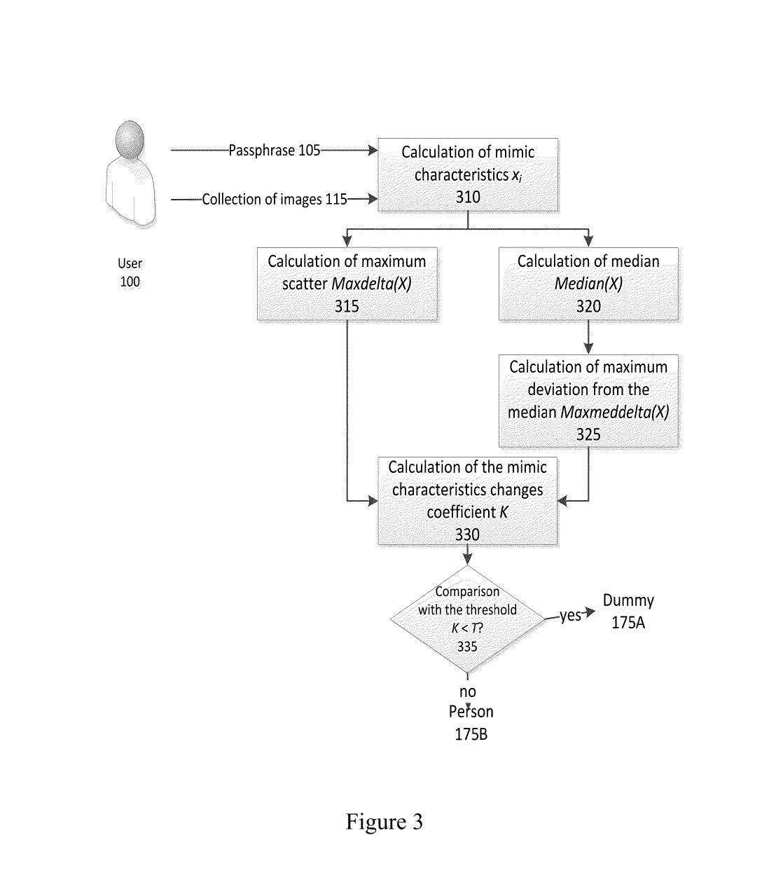

Referring now to FIG. 3 there is shown liveness detection procedure 175 in detail according to one embodiment of the invention

Mimic characteristics are estimated for every image in step 310, including:
probability of mouth opening Pᵢ^{(M)};
probability of right and left eye opening: Pᵢ^{(YL)} and Pᵢ^{(YR)} respectively;
probability of the position of the pupils of the left and right eye in the forward direction Pᵢ^{(GL)} and Pᵢ^{(GR)} respectively,

where i is the ordinal number of an image.

The statistic parameters are calculated for every mimic characteristic including:

1. Median value is determined in Box 325:

$$Median ( X ) = {median}_{i = 1 … N} ( X )$$

where i is the ordinal number of an image;
X={x₁ . . . x_{N}} is the array of characteristics for all images;
xᵢ is the mimic characteristic obtained at the i-th image;
N is the count of images;
median({x₁, . . . x_{N}}) is the median calculation for the array.

2. Maximum deviation from the median is determined on Box 325:

$$Maxmeddelta ( X ) = max ( {x}_{i} - {Median}_{i = 1 … N} ( X ) )$$

3. Maximum scatter is determined in Box 315:

Maxdelta(X)=max(X)−min(X).

The coefficient of the mimic characteristics changes among all the images is calculated in Box 330 according to the formula:

K=w₁Maxdelta({P₁^{(M)} . . . P_{N}^{(M)}})+w₂(Maxdelta({P₁^{(GL)} . . . P_{N}^{(GL)}})+Maxdelta({P₁^{(GR)} . . . P_{N}^{(GR)}}))+,+w₃(Maxmeddelta({P₁^{(YL)} . . . P_{N}^{(YL)}})+Maxmeddelta({P₁^{(YR)} . . . P_{N}^{(YR)}}))

where w₁, w₂, w₃ are weighting coefficients for the mimic characteristics of mouse, eyes opening and pupils position respectively.

After that the obtained coefficient of the mimic characteristics changes K is compared with the threshold T in Box 335, and the license decision 175 on a dummy presence in the image is concluded:
if K<T, then there was a dummy in the images (decision 175A);
if K≧T, then there was a person in the images (decision 175B).

Table 1 below represents the values of the weighting coefficients and the decision threshold, which usage permitted to find experimentally the following errors of liveness detection:
false dummy detection error <1%;
false person detection error ˜23%.

TABLE 1

| | |
|---|---|
| Weighting coefficient w₁ | 0.56 |
| Weighting coefficient w₂ | 0.62 |
| Weighting coefficient w₃ | 0.62 |
| Decision threshold T | 1.0 |

An apparatus intended to realize the invention includes the interrelated data media, central processor unit and graphic interface as described in connection with FIG. 1. The data media contain the computer instructions for making a few photos of the user's face simultaneously with the passphrase pronunciation, for calculation of the mimic facial characteristics for every image, for calculation of the changes coefficient of the mimic characteristics among all the images, for comparison of the obtained coefficient and the threshold value, and for making decision about liveness detection or usage of a dummy during the bimodal authentication procedure. This device may be implemented with using existing computer or multiprocessor systems.

It will be apparent to one of skill in the art that described herein is a novel system, method and apparatus for biometric liveness detection. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

What is claimed is:

1. A method for detecting liveness of a user during an authentication process, the method comprising the steps of:
during a bimodal authentication when a user pronounces a passphrase, collecting a plurality of photos of the user's face over a set of equal time periods;
calculating mimicked facial characteristics for each image;
calculating a coefficient of changes between the mimic facial characteristics of all images;
comparing a coefficient calculated with a predetermined threshold value; and
performing a liveness detection decision based on the comparison.

2. The method according claim 1, where the step of calculating mimicked facial characteristics further comprises determining at least one of the following:
a probability of the user's mouth opening;
a probability of the user's right eye opening;
a probability of the user's left eye opening;
a probability of the position of the user's pupil of the left and right eye in the forward direction and respectively,
a probability of the position of the user's pupil of the left eye in the forward direction; and
a probability of the position of the user's pupil of the right eye in the forward direction.

3. The method according to claim 2 further comprising calculating statistic parameters for each mimic characteristic.

4. The method according to claim 3 further comprising determining a median value.

5. The method according to claim 4 further comprising the step of counting a series of images.

6. The method according to claim 5 further comprising the step of selecting a predetermined ordinal number of an image.

7. The method according to claim 6 further comprising the step of determining a maximum deviation from the median.

8. The method according to claim 7 further comprising the step of determining a maximum scatter.

9. The method according to claim 8 further comprising the step of determining a coefficient of mimic characteristics.

10. The method according to claim 9 further comprising the step of assigning a weighting coefficient for a position of at least one of a user's eyes, mouth, nose and/or pupils.

11. An apparatus consisting a computer storage, a database, a central processor and a gui all electrically interconnected, where the computer storage contains computer software having instructions to:
collect photos over a set time period during the bimodal authentication when pronouncing a passphrase,
calculate mimicked facial characteristics for each image;
calculate a coefficient of changes between the mimic facial characteristics of all images;
compare a coefficient calculated with a predetermined threshold value; and
perform a liveness detection decision based on the comparison.

12. The apparatus according to claim 11 further comprising instructions to calculate statistic parameters for each mimic characteristic.

13. The apparatus according to claim 12 further comprising instructions to determine a median value.

14. The apparatus according to claim 13 further comprising instructions to count a series of images.

15. The apparatus according to claim 14 further comprising instructions to select a predetermined ordinal number of an image.

16. The apparatus according to claim 15 further comprising instructions to determine a maximum deviation from the median.

17. The apparatus according to claim 16 further comprising instructions to determine a maximum scatter.

18. The apparatus according to claim 17 further comprising the step of determining a coefficient of mimic characteristics.

19. The apparatus according to claim 18 further instructions to assign a weighting coefficient for a position of at least one of a user's eyes, mouth, nose and/or pupils.
